(19) United States
(12) Patent Application Publication
(10) Pub. No.: US 2007/0203809 A1
(43) Pub. Date: Aug. 30, 2007

(54) METHOD AND APPARATUS FOR REGULATING STORE INVENTORY

(76) Inventor: Praveen Bapat, Bangalore (IN)

Correspondence Address: KENYON & KENYON LLP, 1500 K STREET N.W., WASHINGTON, DC, 20005, US

(21) Appl. No.: 11/307,858

(22) Filed: Feb. 25, 2006

(51) Int. Cl. G06Q 10/00

(52) U.S. Cl. 705/28

(57) ABSTRACT

Disclosed is a method and system for regulating the amount of stock in a display area to prevent the display area from being depleted of stock, resulting in loss of sales. The system utilizes RFID technology to track the number of stock items in the display area and to compare the number of stock items with an alert point. If the number of stock items falls to or below the alert point, a first alert is sent to a person responsible for replenishing the stock. If after a set period of time, the stock has not been replenished, a second alert is sent to a second person.

### FIELD OF THE INVENTION

The present invention relates to controlling the inventory of a store to reduce the loss of sales to the store due to products not being available to a customer at a given time.

### BACKGROUND

The success or failure of a retail outlet such as a grocery store or clothing store depends largely upon the number of sales of individual items.

Many factors influence the sale of items to consumers, including advertising for that item and environmental conditions (eg hot or cold weather). Additionally, customers will sometimes walk past a display of items and get a sudden “impulse” to buy that item.

Clearly, an important factor in actually selling the item to the customer, whether the customer has come into the store to search for that item, or whether the customer impulsively buys the item, is the actual availability and visibility of the item to the customer when the customer is in the store and in front of the display stand.

If a particular display stand is empty due to other customers having bought the last of the particular item, the customer may simply leave the shop and purchase the item from another store that is displaying the item.

If the customer is aware of the item and comes into the store looking for it, only to find the display stand for the item to be empty, the customer may ask a store assistant if there is another stock of the item, perhaps in the store warehouse. However, many customers will not ask for assistance, or may simply not have time to ask for and wait for the missing item, and just walk out of the store. This results in a lost opportunity of sale to the store.

Furthermore, an unstocked shelf or display area will completely remove the possibility of impulse purchases, because the customer will not be able to see the item for that impulse buy.

A further disadvantage of continually having unstocked shelves is that the store may develop a reputation for having unstocked shelves, and customers may eventually cease frequenting that store, knowing that they will have more luck finding their desired item at another store, which is better able to manage their display areas.

It is therefore an object of the present invention to provide a means of managing the stocking of display areas in a store.

### SUMMARY OF THE INVENTION

In an aspect of the invention, there is provided a system for regulating a stock of at least one item set containing a plurality of items, in a display area. The system includes an identification tag uniquely associated with each item; a reader for reading the identification tag and for communicating data associated with the identification tag to a processor; a database for storing an alert point associated with each of the at least one item set; and the processor for comparing the data received from the reader with the alert point and for generating a first alert to a first person to replenish the display area with items of the at least one item set if the number of items has been reduced to or less than, the alert point for that item set.

In another aspect of the invention, there is provided a method of regulating a stock of at least one item set containing a plurality of items, in a display area. The method includes detecting the number of items in a respective one of the at least one item set; comparing the detected number of items with an alert point associated with that at least one item set; and generating a first alert to a first person if the detected number of items is less than or equal to the alert point.

### BRIEF DESCRIPTION OF THE DRAWINGS

The invention will now be described in detail with reference to the following drawings in which:

FIG. 1 shows illustrative items for sale and use in the present invention;

FIG. 2 shows the elements of a store using the present invention;

FIG. 3 shows an exemplary database storing items of information for use in the present invention;

FIGS. 4A, 4B, 4C and 4D show the status of the database shown in FIG. 3 at different times;

FIG. 5 is a logical flowchart of an item monitoring algorithm used in one aspect of the present invention; and

FIG. 6 is a logical flowchart of a timing algorithm used in another aspect of the present invention.

### DETAILED DESCRIPTION

The present invention will now be described in detail with reference to one or more embodiments of the invention, examples of which are illustrated in the accompanying drawings. The examples and embodiments are provided by way of explanation only and are not to be taken as limiting to the scope of the invention. Furthermore, features illustrated or described as part of one embodiment may be used with one or more other embodiments to provide a further new combination.

It will be understood that the present invention will cover these variations and embodiments as well as variations and modifications that would be understood by the person skilled in the art.

Referring now to FIG. 1, there is shown a collection of items being products for sale to a consumer by a retail shop. In this particular example, item 10 is a box of biscuits (a plurality of which form a first set of items) and item 11 is a can of fruit (a plurality of which form a second set of items). These items are typical of products sold in a food store for example. It will of course be understood that the invention will be applicable to any item or product that can be displayed for individual purchase.

According to an aspect of the present invention, each item has an RFID (Radio Frequency Identification) tag 101 (in the case of box 10) and tag 102 (in the case of can 11), which each contain a unique code which allows each item to be uniquely identified.

As a feature of the RFID system, the information stored on the tag in the form of the code can be transmitted to a nearby receiver via wireless, radio frequency means. This then allows individual items to be interrogated at will and relevant details instantly made available to a database.

An example of a tag device constructed to directly provide information is a read-write RFID tag which has written thereon specific information about a product, such as identity or price information, and communicates such information when sensed by a suitable sensor, as will be described below. An example of a wireless device constructed to indirectly provide information is a read-only RFID tag that, when sensed, communicates limited information, such as a product identity (e.g., a unique electronic product code or categorical identifier), and that product identity is thereafter linked with additional information, such as the product price, stored elsewhere, such as in an electronic database. For example, the electronic product code on a read-only RFID tag, such as a 96-bit passive RFID tag, is a unique serial number which can contain strings that identify the manufacturer and product category, and which can serve as a unique pointer in an electronic database to provide access to stored information such as product composition, manufacturing history, details of the product's supply chain history (dates and times of various shipments, locations of storage, etc.), and its present location and status, all of which can be conveyed electronically by scanning the code associated with the RFID tag and then accessing suitable databases to retrieve information associated with the code.

RFID tags 101,102 are generally small label-like devices with a micro-chip and a miniature embedded antenna. Such smart tags may be passive or active, the active tags requiring an internal power supply. A reader or scanner interrogates the smart tag with an electronic “trigger” signal. The tag in turn generates an electromagnetic signal response that is readable by the scanner, the response containing the product information. RFID tags can be embedded in or attached to product packaging, or incorporated directly into the product, and may convey conventional “bar code” information, as well as other more detailed information.

For example, in FIG. 1, RFID tag 101 could be affixed to the outside of box 10, or on the inside, since it does not need to be visible to the outside world. In some cases RFID tag 101 can actually be printed directly on or inside box 10.

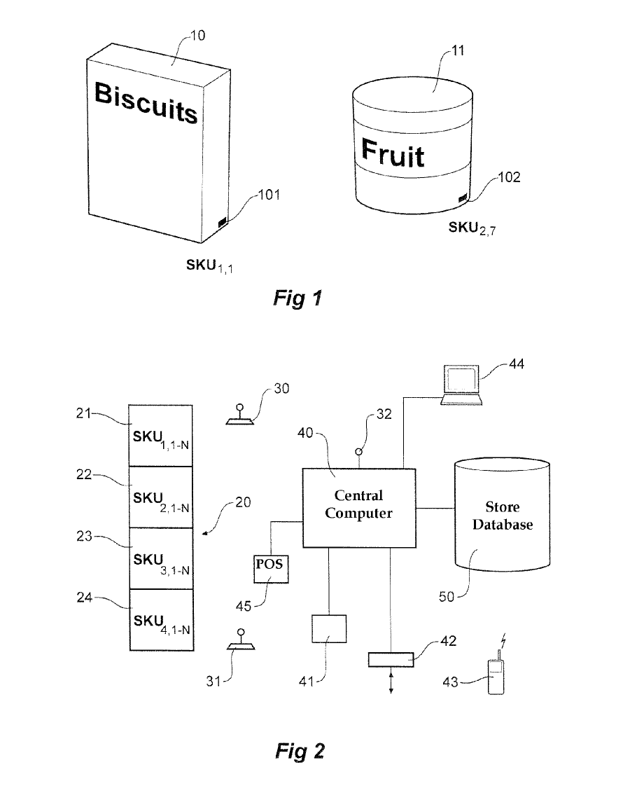

An exemplary arrangement of a store using the present invention is shown in FIG. 2. Block 20 represents a display shelf in the store, for displaying a number of different products or item sets 21, 22, 23 and 24. Products 21 could be a multiple of the product of a particular brand of biscuits in a box as shown in FIG. 1 as 10. Products 22 could be a multiple of a particular brand of canned fruit as shown in FIG. 1 as 11.

As shown in FIG. 2, each product or item set is labelled as an SKU (Stock Keeping Unit). In the case of products displayed in shelf area 20, all of these products of the same set will be denoted by SKU1. Each individual product within that set (containing N products) will be denoted by a subset of this, i.e. SKU_{1,1-N}. In FIG. 1, the box 10 illustrated may be the first box in the set of boxed biscuits of that brand, and is accordingly denoted as SKU_{1,1}. The can of fruit 11 in FIG. 1 may be the seventh can of that brand of canned fruit sold by the store and is therefore denoted as SKU_{2,7}.

Accordingly, every single individual box, can, etc will have a unique identifier code, which is encoded within the code of the RFID tags. Of course, it will be understood that SKUs are simply being used herein as an illustrative embodiment and may be replaced by any other form of unique identification.

Referring back to FIG. 2, disposed in the region of shelf 20, is one or more RFID tag readers 30 and 31. These readers are the devices that receive the code information from each product that is stored on the respective RFID tags of the products. The number of readers 30, 31 used will be entirely dependant upon the particular devices used. In some cases, the range of a particular reader may be sufficient to read every tag in the shop, while in other cases, a number of readers 30, 31 will be required, as will be understood by the person skilled in the art.

Readers 30, 31 are electronic devices that may, for example, comprise an RF transmitter and receiver and an antenna to communicate with RFID transponders, such as RFID tags 101 and 102. Such RFID readers may include a microprocessor and software programs for this purpose. Well known manufacturers of commercially available readers include Matrics®, Inc. and Philips® Semiconductor.

RFID readers 30, 31 may be accessed through respective interfaces (not shown). Such interfaces may be, for example, a standard PC or PDA device incorporating a digital interface designed to facilitate communication between RFID devices and a computing device connected to wired or wireless communication link.

In FIG. 2, the Central Computer 40 will receive data from RFID readers by any suitable means, such as wired connection, or in the exemplary case as shown in FIG. 2, by wireless means, using antenna 32. In an alternative embodiment, the arrangement may simply comprise a single RFID reader operatively connected to the Central Computer 40, for reading all of the RFID tags in the store.

Store Database 50 may contain data relating to several aspects of the operation of the store, including the data collected by readers 30 and 31. As previously described, readers 30, 31 will periodically read the RFID tags within its range and be able to discern which, and how many products are still in their display shelves 20.

The readers 30,31 could read the tags at a preset regularity, or could do so when triggered by an event, such as the closing of display door (e.g. a cooler storing ice cream), or a sensed reduction in weight on a particular shelf, or even the sensing of a customer's hand reaching into the shelf area. Any other for of event suggesting that an item has been removed from shelf 20 might also be used to trigger a reading. After each reading, readers 30, 31 will transmit their data to central computer 40 which will update the stored data relating to the state of products on display shelves 20 with this new data.

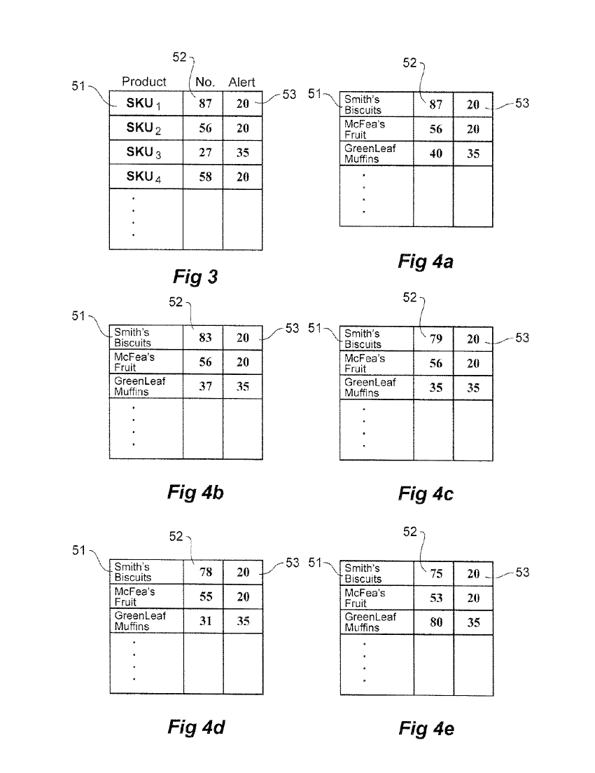

FIG. 3 shows an exemplary form of the data in database 50, relating to the status of products on shelves. The first column 51 lists the product type (e.g. Smith's Biscuits), in this example identified by an SKU number denoted SKU₁. SKU₂ could denote Mcfee's Canned Fruit, SKU₃ could denote GreenLeaf Muffins etc.

The second column 52, stores the actual number of items of that particular product or item set in the shelf 20. For example, in FIG. 3, database 50 indicates that there are currently 87 boxes of Smith's biscuits, 56 cans of McFee's Canned Fruit and 27 packets of Greenleaf muffins.

If a customer now selects one box of Smith's biscuits and 2 cans of Mcfee's canned fruit, the readers 30, 31 will, at their next reading, detect the absence of these products from the shelf 20 and transmit this information to central computer 40. Central computer 40 will then update database 50 to record that there are now 86 boxes of Smith's biscuits and 54 cans of McFee's canned fruit.

It will be appreciated that the readers 30, 31 could be programmed to either send information to Central Computer 40 regarding all tags that they read, or to only transmit information relating to differences between the current read and the previous read. It will also be understood that the RFID technology also allows the identity of the particular item that has been removed to be known, but in this particular embodiment, this information is not required. In this way, it is possible to monitor the number of items of product actually on the display shelf and to replenish the shelf before the items are completely gone.

According to an aspect of the present invention, an alert point is able to be set by the store manager (for example). This alert point relates to the number of items of a particular product or item set in the shelves 20 at which the system of the present invention will issue an alert to a responsible person to indicate that the shelf 20 needs to be restocked with that particular item. In this way, the shelf will always be stocked with product, thus eliminating or reducing the instance of lost sales due to “unavailable” product.

Returning to FIG. 3, column 53 of the data set in database 50 contains these alert points. In particular, the alert point for Smith's biscuits is 20 boxes, that for McFee's canned fruit is 20 cans and that for GreenLeaf muffins is 35 packets. In the example shown in FIG. 3, the actual number of GreenLeaf Muffins (SKU₃), being 27, is less than the alert point of 35. This means that the number of packets of the muffins is less than lowest desired number, and also means that an alert should already have been issued by the system and a responsible clerk of the store should be in the process of replenishing the shelf to restore the number of muffin packets to above the alert point. The alert point can be set manually by the store manager or any other responsible person, and may be selected based on a number of factors.

In one embodiment, the alert point can be a number that has been selected as reasonable from the past history of sales of the particular product. For example, if a particular product does not sell very quickly, the alert point can be set to a relatively low value because it will be unlikely that the remaining items will be sold within the time it takes to replenish that item. If a product sells very quickly, the alert point can be set to a higher value to allow for the fact that the remaining products will sell more quickly before the stock can be replenished.

In another embodiment, the alert point can be modified if a sale event is advertised for a particular product. In this case, the set point can be set higher than usual for this product, since it is more likely to sell more quickly than at a “non-sale” time.

In a further embodiment, the alert points can be adjusted depending upon external factors such as weather. For example, in the summer, ice cream products are more likely to sell quickly than they are in the winter, while hot cakes are more likely to sell more quickly in the winter than they are in the summer.

The setting of the alert point can also be automated using sophisticated statistical methods, and may even automatically obtain data relating to weather or other phenomenon by connection to external databases via the Internet. Referring back to FIG. 2, it can be seen that Central Computer 40 can be connected to external communications networks such as the internet or a cellular or other communications network, via external communications interface 42, as will be understood by the person skilled in the art. If the alert point is being set and entered manually, the data may be entered into Central Computer 40 via user interface 41, which could be a keyboard, a touch screen or any other suitable input device.

A description of an exemplary routine carrying out an aspect of the present invention will now be described in detail. Referring to FIG. 4A, there is shown data in the dataset of database 50 relating to the status of stock in the display shelves 20. For ease of reference, the SKU numbers referred to in FIG. 3 will be replaced by the actual product names. In column 51, there are shown three products or item sets—Smith's Biscuits, McFee's Fruit and GreenLeaf Muffins.

Column 52 shows the current number of items (eg boxes, cans or packets) of that product or item set and column 53 shows the preset alert points set by either the store manager or automatically as previously discussed. In the dataset illustrated in FIG. 4A, all item numbers shown in column 52 are greater than the respective alert points in column 53. This means that all shelves 20 are properly stocked.

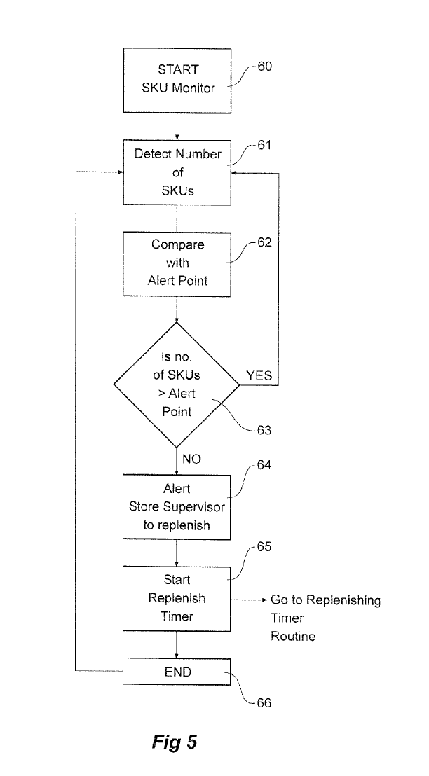

Looking now at FIG. 5, which shows a logical flowchart of the SKU Monitoring procedure 60 according to an aspect of the present invention, the procedure starts at step 61, which detects the number of SKUs or actual items of each product. This data is entered into the Central Computer 40 (see FIG. 2) from the RFID readers 30, 31 as previously described, and entered into the database 50, effectively updating any previously recorded data.

Moving now to step 62, the newly recorded data is compared with each respective alert point set for that product. In step 63, the result of that comparison indicates that the number of SKUs is greater than the respective alert point (meaning that there is sufficient product in the shelf), then the routine loops back to step 61 to receive a new update of product status. In the case as represented by FIG. 4A, all SKUs are greater than their respective alert points, and so the routine 60 will loop back to step 61 for each product to process the routine 60 again using updated data.

In FIG. 4B, there is shown the status of the database 50 at a time after that shown in FIG. 4A. In particular, column 52 shows that since the last routine 60, four boxes of Smith's biscuits have been removed from the shelf, and two packets of GreenLeaf muffins have been removed from the shelf. No cans of McFee's fruit have been removed. In conducting routine 60 again (see FIG. 5) step 61 detects the updated numbers and then proceeds to step 62 to perform the comparison of the updated data with the respective alert points. Once again, since each of the products have items greater than the alert point, the routine loops back to step 61.

FIG. 4C shows the state of the database 50 at the next iteration of routine 60. This time, column 52 shows that four more boxes of biscuits have been removed, and two more packets of muffins have been removed. Again, no cans of fruit have been removed.

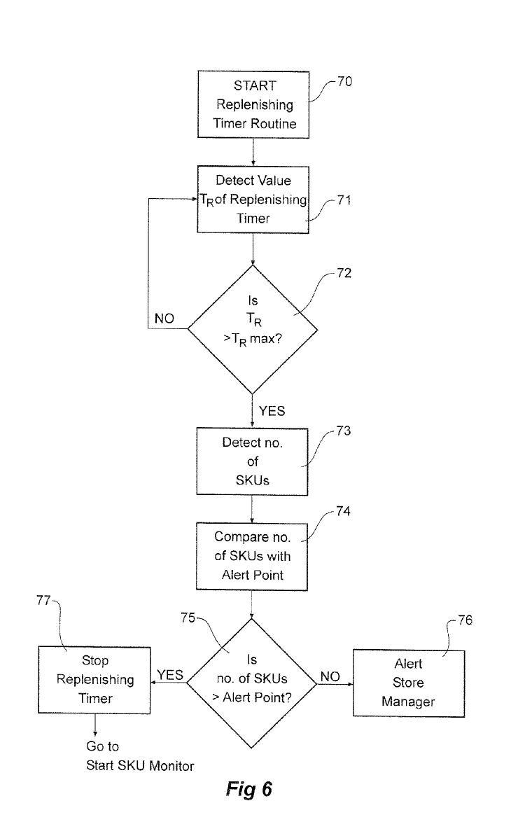

Routine 60 now proceeds to step 62 using the new data, and compares these with the respective alert points in column 53. In the case of the biscuits, the number of boxes remaining is 79, greater than the alert point of 20. Therefore, for the Smith's biscuits, the routine 60 loops back to step 61. The same happens for the canned fruit. However, at steps 62 and 63, routine 60 detects that the number of packets (thirty five) of muffins is equal to the alert point (thirty five) for this product and so routine 60 branches to step 64 to issue an alert to a designated person, for example, the store supervisor. Routine 60 then moves on to step 65 to start a Replenishing Timer, to monitor the time taken to replenish shelf 20 with packets of GreenLeaf muffins to bring the number above the set alert point. Routine 60 then proceeds to Replenishing Timer Routine 70 (FIG. 6) which will be described in more detail below.

The alert that is issued at step 64 may be in a variety of forms. For example, Central Computer 40 could send an email to the designated person's computer terminal 44 (see FIG. 2), or send an SMS (Short Message Service) message to the designated person's cell phone 43 via the external communications system as previously described. Alternatively, the alert could be sent to the person's pager. It will be appreciated that any suitable means could be used.

The format of the message could include information relating to the specific product e.g. GreenLeaf Muffins with corresponding SKU information), where the product is located in shelf 20, how many packets are remaining in shelf 20 and could even suggest the number of packets of muffins to add to the shelf to bring the number to a reasonable level above the set alert point. The alert could also provide the value of the Replenishing Time set for replenishing the shelf 20.

Turning now to FIG. 6, which shows a logical flowchart of the Replenishing Time routine 70 referred to above, the routine is entered at step 71 to detect the amount of time elapsed since having started the replenishing Timer in step 65. In step 72, this detected elapsed time is compared with a preset maximum Replenishing Time RT_{M}.

If the elapsed time is less than RT_{M}, then routine 70 will loop back to step 71 to detect the new elapsed time. If the elapsed time is equal to or greater than RT_{M} then routine 70 proceeds to steps 73 to 75 to compare the number of packets of muffins now detected in shelf 20 with the alert point. If the number of packets is still less than the alert point (as illustrated in FIG. 4D showing the state of the database 50 at a time after that illustrated in FIG. 4C) this means that the store person responsible for replenishing the shelf has not done so. In this case, routine 70 proceeds to step 76 to issue a second alert to another store person, such as the store manager. The alert issued may be issued in the same way as the alert previously described.

This increases the likelihood of the shelf 20 being replenished with packets of muffins before it becomes completely depleted, resulting in possible lost sales. If at step 75, routine 70 determines that the number of packets of muffins is now greater than the alert point (indicating that the responsible store person has replenished the muffins) as illustrated in FIG. 4E, routine 70 will stop the Replenishing Timer and proceed to step 78 to return to SKU Monitor routine 60 to continue monitoring the store's products. Conceivably, the second alert could be sent to the same person responsible for replenishing the display shelf 20 however, sending the alert to a different, more senior person would result in a greater chance of the display shelf 20 being restocked in time.

According to another aspect of the invention, a further backup system for ensuring that the display shelf 20 is replenished is to issue an alert at the point of sale 45 (see FIG. 2) if the item being checked out brings the total number of items for a particular product below the alert point for that product. This additional alert may be provided directly to the sales person who would then contact the store person responsible for replenishing the display shelf (and who would most likely have already been alerted). Alternatively or in addition, the sales person could contact the store manager.

Alternatively, the additional alert could be fully automated and integrated with the system described above to alert the responsible store persons. This additional backup could also provide a failsafe measure if the initial routines 60 and 70 fail, for example if there is a malfunction in one or more of the readers 30, 31 or other part of the system.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

For example, the SKU detection system could be based on systems other than RFID, such as bar codes and associated scanners. In this embodiment, bar code scanners could be located at an edge of each display shelf to read bar codes of items being removed from the shelf. Alternatively, sophisticated weighing systems could be used to indicate the removal of an item from the display shelf and transmit this information to the central computer. Furthermore, while the above has been described with reference to a food store, the various aspects of the invention can be applied to any other store such as a clothing store, sporting goods store or book store.

What is claimed is:

1. A system for regulating a stock of at least one item set containing a plurality of items, in a display area, the system comprising:
an identification tag uniquely associated with each item;
a reader for reading the identification tag and for communicating data associated with the identification tag to a processor;
a database for storing an alert point associated with each of the at least one item set; and
the processor for comparing the data received from the reader with the alert point and for generating a first alert to a first person to replenish the display area with items of the at least one item set if the number of items has been reduced to or less than, the alert point for that item set.

2. The system as in claim 1, further comprising a timer for timing a period beginning from the generation of the first alert.

3. The system as in claim 2 further comprising a second alert generator for generating a second alert if the period exceeds a preset time limit.

4. The system as in claim 3 wherein the second alert is transmitted to a second person, different from the first person.

5. The system as in claim 1 wherein the alert point is determined manually.

6. The system as in claim 2 wherein the alert point is determined by the processor according to information derived externally of the system.

7. The system as in claim 1 further comprising a point of sale alert generator for generating a point of sale alert when an item that is processed at the point of sale reduces the number of items in the at least one item set to or below the alert point for that at least one item set.

8. The system as in claim 1 further comprising an external communications network interface for transmitting the first alert to a communications device connected to the external communications network.

9. The system as in claim 8 wherein the communications device is a computer terminal.

10. The system as in claim 8 wherein the communications device is a cellular telephone.

11. The system as in claim 8 wherein the communications device is a PDA.

12. The system as in claim 1 wherein the identification tag is a Radio Frequency Identification tag and the reader is a Radio Frequency Identification reader.

13. A method of regulating a stock of at least one item set containing a plurality of items, in a display area, the method comprising:
detecting the number of items in a respective one of the at least one item set;
comparing the detected number of items with an alert point associated with that at least one item set; and
generating a first alert to a first person if the detected number of items is less than or equal to the alert point.

14. The method of claim 13 further comprising generating a second alert to a second person if the number of items in the at least one item set has not been replenished to a number greater than the alert point within a predetermined period of time.

15. The method of claim 13 further comprising manually determining the alert point.

16. The method of claim 13 further comprising automatically determining the alert point according to information derived externally to the system.

17. The method of claim 13 further comprising:
at a point of sale, monitoring the number of items in the at least one item set that have been processed at the point of sale and generating a point of sale alert when the number of items remaining in the at least one item set is less than or equal to the alert point for that item set.

18. The method of claim 13 further comprising transmitting the first alert and/or the second alert to a communications device via an external communications network.

19. The method of claim 18 wherein the communications device is a computer terminal.

20. The method of claim 18 wherein the communications device is a cellular telephone.

21. The method of claim 18 wherein the communications device is a PDA.

22. The method of claim 13 wherein the step of detecting the number of items is performed using a Radio Frequency Identification tag and a Radio Frequency Identification reader.

23. A computer readable medium encoded with data representing a computer program that can be used to direct a programmable device for performing the method of claim 13.
